(19) United States
(12) Patent Application Publication
(10) Pub. No.: US 2021/0281780 A1
(43) Pub. Date: Sep. 9, 2021

(54) APPARATUS AND METHOD OF IMAGING

(71) Applicant: WIDR INC., Calgary (CA)

(72) Inventors: Arthur SPIVAK, Calgary (CA); Orly YADID-PECHT, Calgary (CA)

(21) Appl. No.: 16/768,166

(22) PCT Filed: Dec. 3, 2018
(86) PCT No.: PCT/IB2018/059587

§ 371 Date: May 29, 2020

Related U.S. Application Data
(60) Provisional application No. 62/593,333, filed on Dec. 1, 2017.

(51) Int. Cl. H04N 5/353; H04N 5/378

(52) U.S. Cl. CPC H04N 5/3535; H04N 5/378

(57) ABSTRACT

An apparatus and method are provided to improve dynamic range (DR) extension ability, signal to noise ratio (SNR) of CMOS devices. The apparatus includes a memory storage unit, a pixel array, the plurality of pixels configured to generate output based on an amount of light incident on each pixel; a comparator in communication with the pixel array, configured to convert the output to a binary code for storage in the memory storage unit; and a processor in communication with the comparator and the pixel array, configured to determine if the comparator converted the output and to reset the pixel associated with the output when the comparator converted the output. The method includes determining a plurality of digitization points based on a DR requirement; setting a capture time based on a selected digitization point; obtaining a pixel readout; and performing a first conditional digitization on the pixel readout.

### FIELD

The present specification relates generally to an apparatus and method for imaging, and more particularly to an apparatus and method of wide dynamic range imaging.

### BACKGROUND

Wide dynamic range is one of the key features of complementary metal-oxide semiconductor (CMOS) cameras, indicating that the specific sensor is capable to capture successfully very bright and very dark areas of the scene, preserving the details of both regions. Due to interest of industrial and academic society in wide dynamic range capture, numerous approaches have been proposed and implemented.

Generally, wide dynamic range solutions can fall into seven categories: 1) logarithmic sensors that compress their response to light due to their logarithmic relation between voltage and photo-current; 2) lin-log sensors that have a linear and a logarithmic response at dark and bright illumination levels, respectively (i.e., sensors capable of switching between linear and logarithmic modes of operation either by means of external control over the pixel or by light induced DC point change; 3) clipping sensors, in which additional capacitance is extended for an overflowing charge and sometimes fused with extending an alternative exposure time; 4) frequency-based sensors, such as a single photon avalanche photodiode, where the sensor output is converted into a pulse frequency; 5) time-to saturation and time-to-first spike sensors, where each pixel integrates to a predetermined limit, where after surpassing the limit stops the integration until a subsequent frame and the time of the event is being memorized; 6) multiple capture sensors utilizing a global control over the integration time, where a sensor integrates globally over several separate exposures and digitizes, such that the final image is composed by choosing the best pixel values out of the available captures; and 7) autonomous control over the integration time, where each pixel is assigned an integration time adaptively. Such sensors are based on intermediate pixel samplings to determine a future possible saturation, thus each pixel is reset conditionally, based on its individual light intensity during the current frame.

### SUMMARY

A wide dynamic range apparatus and method are provided involving conditional analog to digital conversion and conditional reset. The method automatically sets an integration time for an individual pixel and employs a floating point representation of the pixel value using the mantissa and exponent terms. The time adjustment is performed by assigning the integration time of the brighter pixels first, while the darker pixels have their capture time set subsequently down the frame. Such an arrangement allows for digitizing the mantissa for the assigned pixels and for generating the exponent bits, thus eliminating repetitive read/write cycles from/to a dedicated memory, storing the wide dynamic range bits for each subsequent extension bit generation. The proposed algorithm maintains the advantages of dynamic range extension ability, signal to noise ratio, and provides the improved speed of operation, allowing the method to be implemented on any matrix size and in either rolling or global shutter operation modes.

In accordance with an aspect of the invention, there is provided a CMOS apparatus having a capture mode of operation. The apparatus includes plurality of pixels, associated with a CMOS sensor and being connected during the capture mode of operation to receive from the associated CMOS sensor an associated sensor signal that varies at a rate depending on incident light on the associated CMOS sensor. The apparatus may further sample a pixel and convert the obtained signal by at least one comparator to a binary code, upon which an analog to digital conversion (digitization) of the pixel sampled value may or may not occur. If the digitization occurs, the binary code and the digitized result of the conversion will be stored at a memory unit associated with the CMOS sensor and the associated pixel will be reset. If the digitization does not occur, the pixel is not reset. A pixel may include a photo-sensing element and plurality of transistors, implementing reset and readout.

The apparatus may include a pixel sharing the same row, and readout, digitized conditionally and assigned to a single or to a plurality of scanning channels.

The apparatus may include pixel rows converted by a plurality of comparators or single comparator per column, having a plurality of conversion thresholds or a single conversion threshold, set by an upper and lower pixel readout level, signal to noise ratio (SNR), lower and upper integration period limits.

In accordance with another aspect of the apparatus, there is provided a method of allocating integration periods to an apparatus, where those organized in an ascending order and where after each integration period, a pixel readout and a conditional digitization occur. The method may further involve a pixel scan by a plurality of comparators, which conditionally initiate the digitization of the pixel by generating a binary code. The conditional digitization may be done by an analog to digital converter (ADC). Where digitization occurs, both the digitization result and the comparators' binary code may be memorized. If the signal comprises negative charge, the first digitization and reset may be applied to every pixel, discharged below the highest threshold value of the plurality of comparators. If the signal comprises positive charge, the first digitization and reset may be applied to every pixel, charged above the lowest threshold value of the plurality of comparators. When starting from and including the second conditional digitization, if the signal is a negative charge, the digitization and reset may be applied to pixels discharged below the highest threshold and not discharged below the lowest threshold. When starting from and including the second conditional digitization, if the signal is a negative charge, the reset may be applied, but no digitization may be applied to pixels, discharged below the lowest threshold. When starting from and including the second conditional digitization, if the signal is a negative charge, neither reset, nor digitization may be applied to pixels, not discharged below the highest threshold. When starting from and including the second conditional digitization, if the signal is a positive charge, the digitization and reset may be applied to pixels, charged above the lowest threshold and not charged above an upper threshold. When starting from and including the second conditional digitization, if the signal is a positive charge, the reset, but no digitization may be applied to pixels, charged above the highest threshold. When starting from and including the second conditional digitization, if the signal is a positive charge, neither reset, nor digitization may be applied to pixels, not charged above the lowest threshold.

In accordance with another aspect of the apparatus, there is provided a method of allocating integration periods to an apparatus, where after each integration period, a digitization cycle occurs, followed by a conditional reset operation, during which the digitized value of the pixel is compared to the relevant combinations of threshold values, which can be either digital or analog voltages or currents. If the signal is negative charge, the reset may be applied to the pixel if: 1) its digitized value is below the highest threshold; or 2) its digitized value is below the highest threshold and above the lowest threshold; or 3) its digitized value is below the lowest threshold.

In accordance with another aspect of the apparatus, there is provided a method of allocating integration periods to an apparatus, where after each integration period, a digitization cycle occurs, followed by a conditional reset operation, during which the digitized value of the pixel is compared to the relevant combinations of threshold values, which can be either digital or analog. If the signal is positive charge, the reset may be applied to the pixel if: 1) its digitized value is above the lowest threshold; or 2) its digitized value is above the lowest threshold and below the lowest threshold; or 3) its digitized value is above the highest threshold.

### BRIEF DESCRIPTION OF THE DRAWINGS

Reference will now be made, by way of example only, to the accompanying drawings in which:

FIG. 1 is a schematic diagram of a designed low light, high sensitivity sensor chip in accordance with an embodiment;

FIG. 2 is a schematic of a proposed CADR system in accordance with an embodiment;

FIG. 3 is a representation of CADR integration periods and digitization points;

FIG. 4 is a graph showing a first digitization cycle;

FIG. 5 is a graph showing a second digitization cycle;

FIG. 6 is a graph showing a last digitization cycle;

FIG. 7 is a graph showing a first check quantization;

FIG. 8 is a graph showing a second check quantization;

FIG. 9 is a flowchart showing the “stitching” of the quantization within subsequent time checks;

FIG. 10 is a schematic of a CADR system in in accordance with an embodiment; and

FIG. 11 shows a changed order of mantissa and exponent processing.

### DETAILED DESCRIPTION OF THE EMBODIMENTS

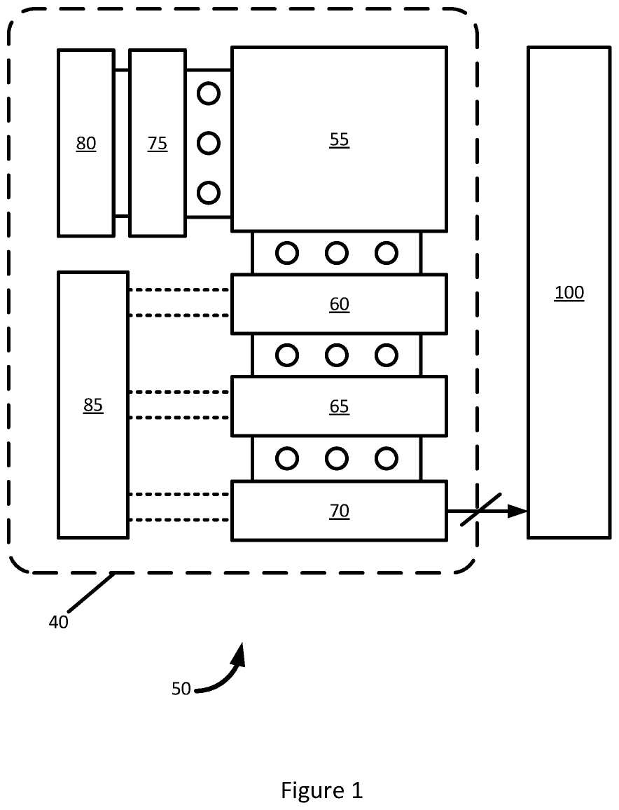

Referring to FIG. 1, the overall system is generally shown at 50. In the present embodiment, the system is a CMOS camera. The system includes a chip 40 having a pixels' array matrix 55 having M columns and N rows controlled by a row logic engine 75, coupled to a row decoder 80. In the present example, each the pixel array is to receive an amount of light incident on the pixels to generate a response. At a predetermined time point, the pixels' rows are selected and scanned unconditionally to comparator units 60. It is to be appreciated by a person of skill in the art that the exact number of the comparator units 60 is not particularly limited. In the present embodiment, the number of comparator units 60 is selected to allow for the scanning column-parallel. The determinations made by the comparator units 60 are fed to a conditional analog to digital converter 65, where the conversion of a pixel will be performed if it meets one or more threshold values. The conditional analog to digital converter 65 calculates the mantissa and a time check determines the exponent value. The conditional analog to digital converter 65 is coupled to a column decoder 70, thus the output from the system contains both components.

In addition, the output from the system containing digital data can be scanned into an off-chip frame buffer 100, where the output can be stored prior to being streamed for a final processing before presentation on a screen. It is to be understood by a person of skill in the art with the benefit of this description that the data stream can be conditional as well, since the digitized pixels will be updated after a certain time check. The chip 40 may also include other components such as a bias and ramp generators 85 to provide functionality to the comparator units 60, the conditional analog to digital converter 65 and the column decoder 70. A pixel may also include a photo-sensing element and plurality of transistors, implementing reset and readout. In other examples, the photo-sensing element may be used to generate row output, which is a collection of the output from a row of pixels

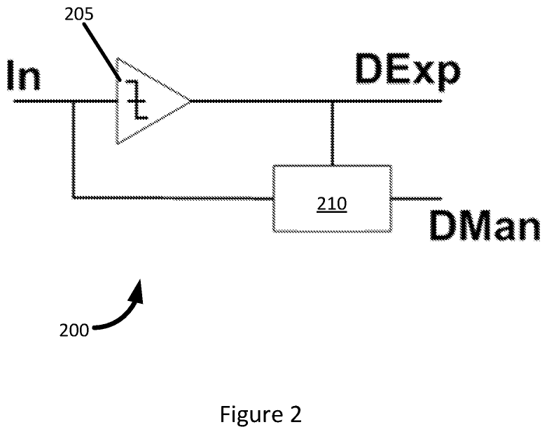

Referring to FIG. 2, an embodiment of a conditional analog to digital conversion and conditional reset (CADR) is generally shown at 200. The CADR includes two analog to digital converter cycles: 1) one or more comparators 205, producing exponent values DExp; and 2) analog to digital converter 210, producing the mantissa value DMan. In the present embodiment, CADR arrangement, the wide dynamic range processing precedes the mantissa, being a condition to activation of the analog to digital converter 210. It is to be appreciated by a person of skill in the art that the CADR shown in FIG. 2 is not particularly limited and that different arrangements and/or component sharing may be substituted for some components shown in FIG. 2 which may change the order of DMan and DExp processing. For example, the comparators may be modified to be off-chip.

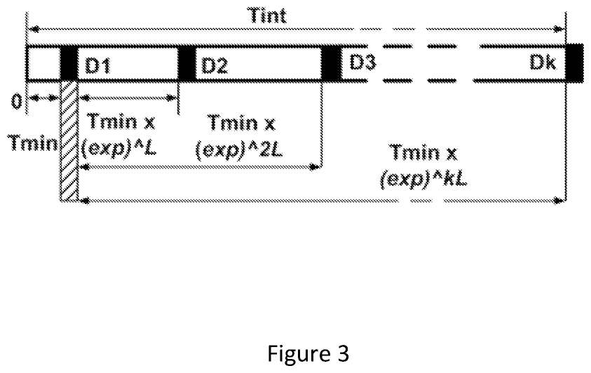

In the present embodiment, CADR realization may be subdivided to several time checks, further called digitization points D1 . . . Dk ordered in a geometrically progressive order as shown in FIG. 3.

The first digitization check is set by an upper DR requirement. Knowing the inherent dynamic range DRᵢ, set by an analog to digital converter and a pixel swing, and knowing the total dynamic range DRₜₒₜ, the extended range DRₑₓₜ, can be defined as:

DRₜₒₜ=DRᵢ×DRₑₓₜ (1)

The longest exposure Tᵢₙₜ will be scaled down accordingly to set the shortest integration period Tₘᵢₙ using:

$${T}_{min} = \frac{{T}_{int}}{D {R}_{e x t}} \qquad ( 2 )$$

The subsequent digitization points Di can be derived upon the ratio exp, and the number of bits L, generated at every point. In general the i-th digitization point can be defined as:

Dᵢ=Tₘᵢₙ×(exp)^{(i-1)/L} (3)

where L is the number of bits, generated at each digitization point.

Accordingly, it is to be appreciated by a person of skill in the art that ratios between the subsequent digitization points can be arbitrarily set to any positive real value using:

$$\frac{{D}_{i}}{{D}_{i - 1}} = {( exp )}^{L} \qquad ( 4 )$$

Therefore, an upper limit of the ratio between the digitization points satisfies:

(exp)^{kL}=DRₑₓₜ (5)

As an example of an implementation of the present embodiment, it can be assumed that the dynamic range is to be extended by 4096 (72 dB) to generate 12 bits of wide dynamic range data. When 2 bits are generated each cycle (L=2) and base 2 (exp=2), there will be six digitization points (k=6) and according to equation (4), the time ratio between the successive digitization cycles is 4. Accordingly, if Tᵢₙₜ can be assumed to be 16 ms, D1 will be 3.9 μs; D2 will be 15.6 μs; D3 will be 62.5 μs; D4 will be 250 μs; D5 will be 1 ms; and D6 will be 4 ms. It is to be appreciated by a person of skill in the art that the time difference between the first digitization points are so low, that it might not be possible to make the integration periods between the digitization points as overlapping as shown in FIG. 3, where the second capture starts after D1 is finalized. However, as the time difference grows, the captures indeed may overlap. The duration of each digitization cycle is set by the system clock frequency, number of analog to digital converters for each row, and the matrix size.

In the first digitization cycle of the present embodiment, conditional analog to digital converter cycles are implied at each of the digitization points, such that that pixels receiving saturating or near saturating intensities, are to be digitized and reset, while the pixels having less intense input, will not be digitized and/or reset. The pixel swing is subdivided such that if a certain light intensity discharges slightly above the upper threshold, the pixel will not be converted, but in the subsequent exposure, the pixel will discharge to the lower threshold, so that no signal will be skipped. In other words, until the point Dᵢ, pixel swing S is reduced by a factor of Q, whereas by the point Dᵢ₊₁, it is reduced by (Q−1)/Q according to:

$$S - \frac{S}{Q} ( {exp}^{L} ) = \frac{S}{Q} ⇒ Q = ( {exp}^{L} ) + 1 \qquad ( 6 )$$

It is to be appreciated by a person of skill in the art that S(Q−1)/Q and S/Q will be the upper threshold and the lower threshold, respectively.

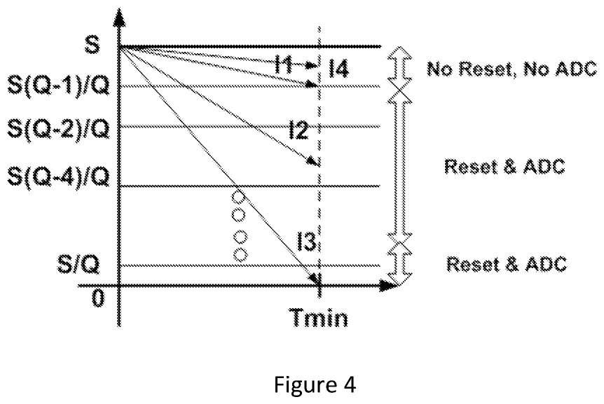

As an example of an implementation of the present embodiment, it can be assumed that there are four different light intensities I4<I1<I2<I3 provided. Referring to FIG. 4, the vertical axis can sub-divided to well-defined levels by the pixel full swing S and the time integration ratios Q from equation (6). Continuing with this example, light intensities I1-I4 fall within different intervals and therefore, processed differently by the system. I1 and I4 are the weakest signals, which by Tₘᵢₙ do not breach the first interval level S(Q−1)/Q, meaning that they are too early to be digitized. However, I2 and I3 surpass the upper threshold, and thus their values (mantissa) are going to be digitized and will be assigned exponent values (exp)\hat{ }(L(k−3)) and (exp)\hat{ }(Lk), respectively. Every pixel, digitized will be reset, for preventing blooming. After the digitization, it is to be appreciated that whether a pixel will saturate or not, since the relevant information would have been captured.

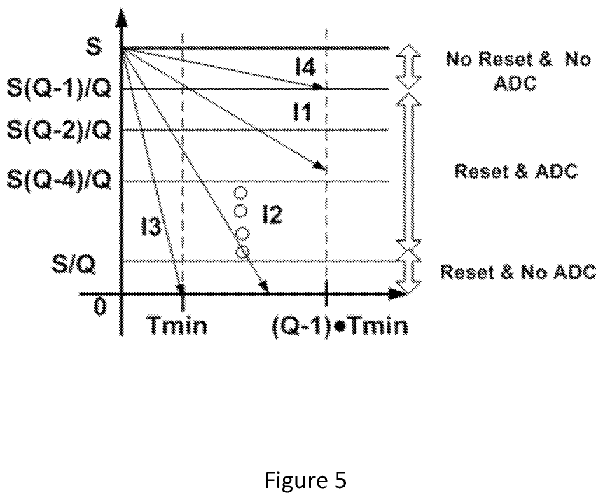

In subsequent digitization cycles of the present embodiment, checks may occur at the times (Q−1)×Tₘᵢₙ, (Q−1)²×Tₘᵢₙ . . . (Q−1)^{(k-1)}×Tₘᵢₙ. Referring to FIG. 5, the second digitization check is shown. Now, I1 intensity has gained enough charge and is ready to be digitized. However, I4 still falls short from the threshold for digitization. Accordingly, I4 will neither be converted nor reset. I2 and I3, which were already converted in the first check, are reset, but not digitized in order not to override the existing data. Furthermore, both I2 and I3 fall within the lowest segment of the pixel swing S/Q, indicating that they have been already digitized. Subsequent digitization points are exact replicas of the second one. Accordingly, by the proposed temporal checks and the corresponding pixel output levels division, reading back the information from the previous digitization from a memory, making the data generation substantially faster.

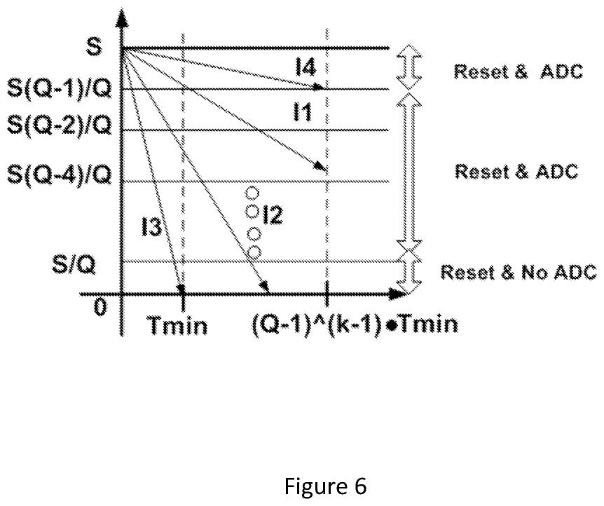

At the last integration time slot, the conversions are performed to all the levels, including the top slot, but still excluding the lowest one as shown in FIG. 6. Accordingly, the darkest pixels will be digitized, preventing any data loss. It is to be appreciated by a person of skill in the art that the proposed swing division is just one variant to provide a constant integration slots ratio defined in equation (4). In other embodiments, the CADR process can be expanded to any arbitrary exposures ratios.

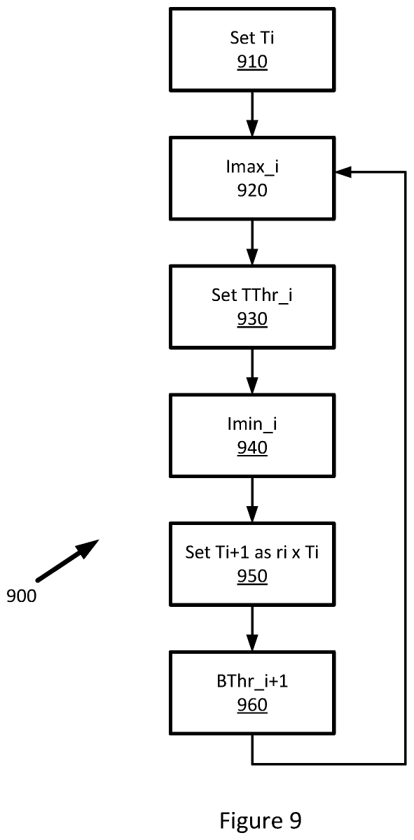

For example, the pixel swing S can be subdivided to suite arbitrary ratios rᵢ between the check points Dᵢ. In this embodiment, each quantization is “stitching” between the different time checks, such that the upper light intensity at the i-th check I_{max_i} can cover the whole available swing to the lower threshold BThr_i, whereas the lowest detectable current I_{min_i} will discharge to the upper threshold TThr_i and the same light intensity will discharge to the BThr_i+1 in the subsequent i+1-th check. This way, no data will be lost. An example of a method showing the stitching is generally shown at 900 in FIG. 9 by steps 910 to 960.

Based on the outline above, a model can be derived for the pixel swing quantization, such as one with multiple available exposures satisfying the following:

Tₘᵢₙ,r₁Tₘᵢₙ,r₂Tₘᵢₙ, . . . rᵢTₘᵢₙ rᵢ>rᵢ₋₁> . . . r₁>1 (7)

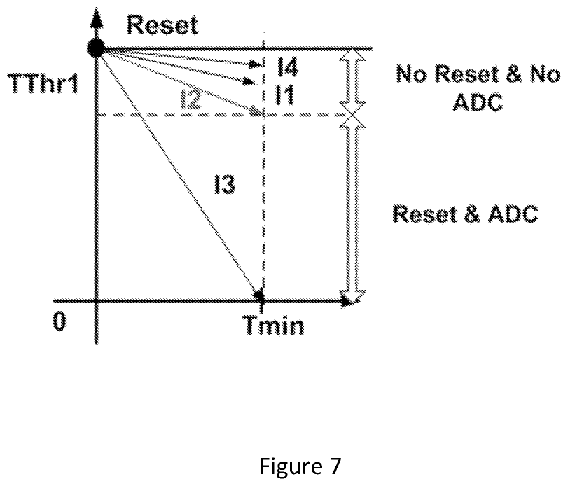

The following distribution can be obtained where intensity I3 is the greatest (Imax_1) that can be detected within Tₘᵢₙ:

$${I}_{3} = {I}_{max \_ 1} = \frac{{C}_{eff} S}{{T}_{min}} \qquad ( 8 )$$

where C_{eff} is the effective light integrating capacitance. It is to be appreciated that the lower threshold is not defined for the first check. However, the upper threshold TThr_1 is defined and will set the in this case I2 according to (and illustrated in FIG. 7):

$${I}_{2} = {I}_{min \_ 1} = \frac{{C}_{eff} ( S - TThr\_ 1 )}{{T}_{min}} \qquad ( 9 )$$

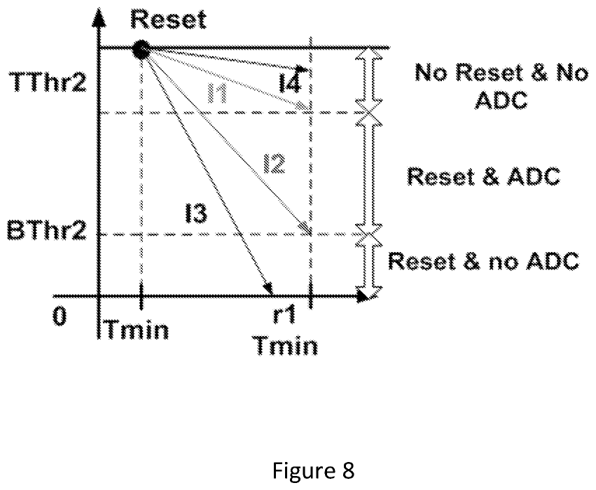

In this embodiment, the setting of I2 and TThr_1 is arbitrary, but is bounded by the comparator gain and offsets. In a second check, occurring after r₁Tₘᵢₙ, the resulted signals by the four signals is shown in FIG. 8.

Subsequently, I2 becomes I_{max_2}, and I3, which is greater will discharge below the lowest conversion limit BThr_2 and will not be converted at all as shown in FIG. 7. Since the value of I2 was determined from equation (9), Bthr_2 can be determined based on:

$${I}_{2} = {I}_{min \_ 2} = \frac{{C}_{eff} ( S - BThr\_ 2 )}{{r}_{1} {T}_{min}} \qquad ( 10 )$$

Since equation (9) equals equation (10), the following should hold:

$${I}_{2} = {I}_{max \_ 2} = {I}_{min \_ 1} = \frac{{C}_{eff} ( S - BThr\_ 2 )}{{r}_{1} {T}_{min}} = \frac{{C}_{eff} ( S - TThr\_ 1 )}{{T}_{min}} ⇒ \frac{S - BThr\_ 2}{{r}_{1}} = S - TThr\_ 1 \qquad ( 11 )$$

The upper threshold TThr_2 and the lower detectable intensity I1 limit for the second check are:

$${I}_{1} = {I}_{min \_ 2} = \frac{{C}_{eff} ( S - TThr\_ 1 )}{{r}_{1} {T}_{min}} \qquad ( 12 )$$

Accordingly, knowing r₂ and I1, TThr_2, the lower threshold for the third check will be determined similarly to the calculation shown in equation (11). The presented “stitching” should be repeated as shown in FIG. 9 by moving to step 920 after the execution of step 960.

In other embodiments, a CADR structure having separate comparator, performing wide dynamic range extension, and providing a preliminary condition to perform a full scale analog to digital converter is provided. It is to be understood that sharing components like comparators between the analog to digital converter and those, responsible for the wide dynamic range processing to reducing the amount of circuitry needed for the CADR implementation.

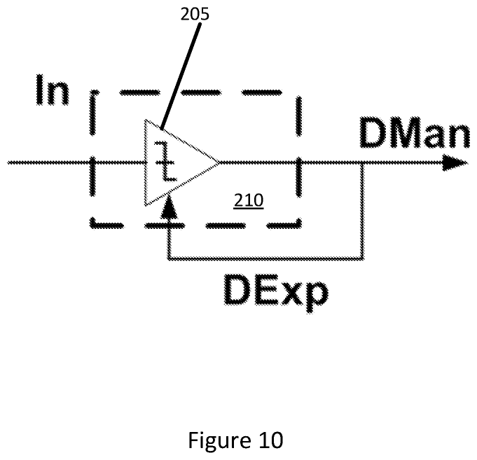

In another embodiment, the comparator 205 for wide dynamic range processing can be accommodated inside the analog to digital converter 210 as shown in FIG. 10. Thus, the ADC output produces DExp and DMan components at different phases of the CADR algorithm

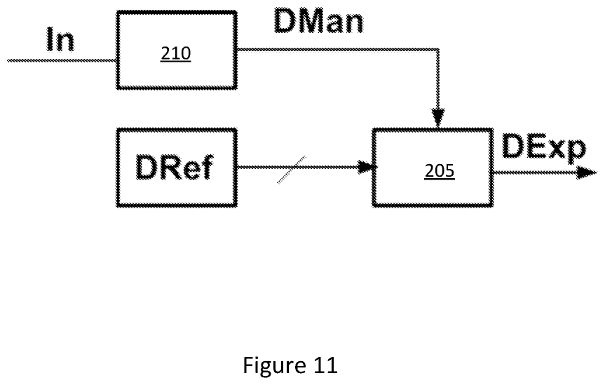

It is to be appreciated that further modifications are also contemplated. For example, the order of the mantissa and exponent production can be changed as shown in FIG. 11. The digital mantissa DMan can be produced and then compared to exponentially spaced references S(Q−i)/Q (see FIG. 5), which were digitized ahead and stored within the DRef (see FIG. 11). Therefore, the comparator 205 for producing the exponent, which can be extremely beneficial in terms of power and the silicon area needed to implement the CADR algorithm, can be omitted.

Various advantages will now be apparent to a person of skill in the art. For example, an improved analog to digital conversion is provided where the conversion is conditional and starts when the signal to noise ratio is sufficient. Accordingly, this reduces under-exposed pixels, and poor signal to noise ratios at short exposures. Accordingly, the analog to digital conversion described above reduces missing codes in over-exposed pixels.

Additional advantages will now be also become apparent. Of note is that the embodiments described herein provide a wide dynamic range process involving conditional analog to digital conversion and reset (CADR), which implements a floating-point analog to digital conversion using temporally dispersed, conditional analog to digital pixel value conversions. The integration periods between the conditional conversions can be organized in an ascending order, ensuring that the brightest pixels are quantized first, such that the mantissa and exponent are produced after short captures and substantially before a frame ends. The derived thresholds provide improved pixel differentiation between successive integration periods. In particular, the lower threshold avoids a data override for already quantized pixels, while the upper threshold avoids the reset for under exposed pixels. Using CADR, the need for digital information on the previous integration cycles is not required, which reduces the number of operations required for the wide dynamic range imaging process. Accordingly, the computational resources used by the system are reduced allowing for increase speed of operation and/or reduction in the computational power of the system. Furthermore, the wide dynamic range process is independent of the matrix size.

As another example of an advantage, the wide dynamic range process sustains a uniform digital resolution and reduces the hardware circuitry for all the illumination levels compared conventional analog to digital solutions. In addition, the wide dynamic range process circumvents the data loss of over exposed pixels.

While specific embodiments have been described and illustrated, such embodiments should be considered illustrative only and should not serve to limit the accompanying claims.

1. An apparatus for imaging, the apparatus comprising:
a memory storage unit;
a pixel array having a plurality of pixels, the plurality of pixels configured to generate output, wherein the output is based on an amount of light incident on each pixel of the plurality of pixels;
a comparator in communication with the pixel array, the comparator configured to convert the output to a binary code for storage in the memory storage unit; and
a processor in communication with the comparator and the pixel array, the processor configured to determine if the comparator converted the output and to reset the pixel associated with the output when the comparator converted the output.

2. The apparatus of claim 1, wherein a pixel of the plurality of pixels comprises:
a photo-sensing element; and
a plurality of transistors for implementing a reset and a readout.

3. The apparatus of claim 2, wherein the plurality of transistors is to reset the plurality of pixels after the comparator converts the output to the binary code.

4. The apparatus of claim 3, wherein the pixel is reset based on a value of the binary code.

5. The apparatus of claim 2,
further comprising a scanning channel, wherein the scanning channel is associated with a row of the pixel array.

6. The apparatus of claim 5, wherein the photo-sensing element is to scan the row of the pixel array.

7. The apparatus of claim 6, wherein the photo-sensing element generates row output.

8. The apparatus of claim 7, wherein the comparator convers the row output to binary code using a plurality of conversion thresholds.

9. The apparatus of claim 1, wherein the comparator includes an analog to digital converter to convert the output.

10. A method of allocating integration periods, the method comprising:
determining a plurality of digitization points based on a dynamic range requirement;
setting a capture time based on a digitization point selected from the plurality of digitization points;
obtaining a pixel readout after the capture time; and
performing a first conditional digitization on the pixel readout to generate a digitized value.

11. The method of claim 10, wherein performing the first conditional digitization comprises performing the first conditional digitization with a comparator.

12. The method of claim 11, wherein the comparator includes an analog to digital converter.

13. The method of claim 10, further comprising resetting a pixel after performing the first conditional digitization.

14. The method of claim 13, wherein resetting the pixel is selectively carried out when the digitized value is below a threshold.

15. The method of claim 14, wherein resetting the pixel is selectively carried out when the digitized value is within a range.

16. The method of claim 10, further comprising a second conditional digitization.

17. An apparatus for imaging, the apparatus comprising:
a memory storage unit;
a pixel array having a plurality of pixels, the plurality of pixels configured to generate output, wherein the output is based on an amount of light incident on each pixel of the plurality of pixels;
a plurality of transistors for implementing a reset on each pixel of the plurality of pixels; and
a processor in communication with the plurality of transistors, the processor to determine when to reset the pixel based on the output associated with the pixel.

18. The apparatus of claim 17, further comprising a plurality of comparators in communication with the plurality of pixels, wherein each comparator of the plurality of comparators is associate with a pixel of the plurality of pixels.

19. The apparatus of claim 18, wherein each comparator of the plurality of comparators is to convert the output to a digital value for storage in the memory storage unit.

20. The apparatus of claim 18, wherein each comparator of the plurality of comparators includes an analog to digital converter to generate the digital value.
